(19) United States
(12) Patent Application Publication
(10) Pub. No.: US 2024/0213615 A1
(43) Pub. Date: Jun. 27, 2024

(54) VENTING AND SEPARATING DEVICE FOR HOUSING OF BATTERY

(71) Applicant: MANN+HUMMEL GmbH, Ludwigsburg (DE)

(72) Inventors: Robert ZBIRAL, Marbach (DE); Daniel VOLKMER, Hemmingen (DE); Robert KUSEBAUCH, Landau (DE); Ludwig BAMMERSPERGER, Reisbach (DE); Klaus GEHWOLF, Mamming (DE)

(21) Appl. No.: 18/597,859

(22) Filed: Mar. 6, 2024

Related U.S. Application Data
(63) Continuation of application No. PCT/EP2022/079375, filed on Oct. 21, 2022.

(30) Foreign Application Priority Data
Nov. 8, 2021 (DE) 102021128948.3

(51) Int. Cl. H01M 50/333; F16K 17/04; H01M 50/103

(52) U.S. Cl. CPC H01M 50/333; F16K 17/04; H01M 50/103

(57) ABSTRACT

A venting and separating device for a housing of a battery includes a base body including a circumferentially extending rim configured to couple to the housing, an inlet opening configured to be in fluid communication to an interior of the housing, an outlet opening configured to be in fluid communication with an environment, a first separation screen including first screen openings engaging across the inlet opening, and a second separation screen in a venting flow direction fluidically downstream of the first separation screen, the second separation screen including second screen openings engaging across the outlet opening. The base body further includes a pressure relief valve configured to open, when a predetermined excess pressure in the housing is surpassed, a bypass fluid flow path from the interior of the housing to the environment, the bypass fluid flow path bypassing both the first separation screen and the second separation screen.

### CROSS-REFERENCE TO RELATED APPLICATIONS

This application is a continuation application of International Application No. PCT/EP2022/079375 filed on Oct. 21, 2022, which claims the benefit of German Application No. 102021128948.3 filed on Nov. 8, 2021, the entire disclosures of which are incorporated herein by reference for all purposes.

### BACKGROUND

The invention concerns a venting and separating device for a housing of a battery, in particular of a traction battery of a motor vehicle, as well as a housing of a battery, in particular of a traction battery of a motor vehicle, for receiving battery cells.

Housings for receiving electronic components such as, for example, battery cells and the like, are usually not closed off completely gas-tightly relative to the environment. On the one hand, due to temperature fluctuations, for example, due to heat introduction during charging or discharging of battery cells, and, on the other hand, due to naturally occurring air pressure fluctuations, in particular in mobile systems, a gas exchange between interior and exterior is to be enabled. Due to the gas exchange, impermissible mechanical loads of the housing, in particular bursting or bulging of the housing, can be prevented. On the other hand, in particular in battery housings, an emergency venting function must be present in case of sudden pressure increase due to failure of battery cells because otherwise the housing could become damaged.

Likewise important is however that the ingress of foreign bodies, dirt, and moisture in form of liquid water is effectively prevented. Therefore, pressure compensation devices are known that comprise semipermeable membranes, for example, of extruded polytetrafluoroethylene (PTFE), that are gas-permeable but liquid-impermeable.

DE 10 2012 022 346 B4 discloses a degassing unit for a battery housing that comprises a base body that comprises a gas passage opening which is covered by a semipermeable membrane that is permeable for gases but impermeable for liquids, wherein the membrane is connected stationarily and fluid-tightly to the base body, in particular welded. The base body is fluid-tightly connectable to a pressure compensation opening of the battery housing. The membrane ensures a gas exchange in normal operation by its semipermeable properties while, for realizing an emergency degassing function, an emergency degassing spike pointing toward the membrane is arranged at a cover body and, when an expansion limit induced by a housing inner pressure is surpassed, perforates the membrane and causes it to rupture so that a sudden pressure compensation from the interior to the environment is possible. At an inner side which is facing the battery housing in a mounted state, an inner protective grid is connected to the base body that is to prevent ingress by means of foreign bodies into the battery housing and that supports the membrane against water pressure from the exterior.

### SUMMARY

It is an object of the invention to provide a venting and separating device for a housing of a battery, in particular of a traction battery of a motor vehicle, which enables a quick venting of the housing with minimal pressure loss and prevents the escape of particles.

A further object is to provide a housing of a battery which enables a quick venting with minimal pressure loss and prevents the escape of particles.

The aforementioned object is solved according to an aspect of the invention by a venting and separating device for a housing of a battery, in particular of a traction battery of a motor vehicle, comprising a base body with a circumferentially extending rim, which is provided for coupling to the housing, wherein the base body comprises at least one inlet opening and at least one outlet opening, wherein the at least one inlet opening for intended mounting at the housing is connectable in fluid communication to an interior of the housing, and the at least one outlet opening is in fluid communication with an environment, wherein the base body comprises at least one first separation screen with first screen openings engaging across the inlet opening and comprises, in a venting flow direction fluidically downstream of the first separation screen, a second separation screen with second screen openings engaging across the outlet opening, wherein the venting and separating device comprises at least one pressure relief valve that is configured to open, when a predetermined excess pressure in the housing is surpassed, a bypass fluid flow path from the interior of the housing to the environment, wherein the bypass fluid flow path bypasses at least one of the separation screens.

That the inlet opening of the base body “is connectable in fluid communication” with the interior of the housing for intended mounting can mean that, in the mounted state, it is always in fluid communication with the interior of the housing and, on the other hand, this term encompasses also situations in which the fluid communication between the interior of the housing and the inlet opening of the base body is produced only in case of an emergency venting event, for example, due to triggering of a pressure relief valve and/or bursting of a membrane or of a burst disk.

In other words, for the feature “is connectable in fluid communication”, it is sufficient when the base body can be mounted at the housing such that its inlet opening in at least some operating states of the housing may be in fluid communication with the interior of the housing.

The further object is solved according to a further aspect of the invention by a housing of a battery, in particular of a traction battery of a motor vehicle, for receiving battery cells, comprising at least one housing wall with at least one housing opening, wherein the housing opening is closed by a venting and separating device, in particular at an exterior side of the housing wall.

Beneficial embodiments and advantages of the invention result from the additional claims, the description, and the drawing.

According to an aspect of the invention, a venting and separating device for a housing of a battery, in particular of a traction battery of a motor vehicle, is provided that comprises a base body with a circumferentially extending rim, which is provided for coupling to the housing, wherein the base body comprises at least one inlet opening and at least one outlet opening, wherein the at least one inlet opening for intended mounting at the housing is in fluid communication with an interior of the housing, and the at least one outlet opening is in fluid communication with an environment. The base body comprises at least one first separation screen with first screen openings, engaging across the inlet opening, and, in a venting flow direction fluidically downstream of the first separation screen, a second separation screen with second screen openings engaging across the outlet opening.

The venting and separating device comprises at least one pressure relief valve that is configured to open, when a predetermined excess pressure in the housing is surpassed, a bypass fluid flow path from the interior of the housing to the environment, wherein the bypass fluid flow path bypasses at least one of the separation screens. In other words, the bypass fluid flow path branches off at a location of the venting flow direction that is fluidically upstream (or “in front of”) at least one of the separation screens.

In an exemplary embodiment, the circumferentially extending rim of the base body, by means of which the base body is coupled to the housing, is coupled substantially fluid-tightly to the housing. In other embodiments, a gap may also be provided however between the rim of the base body and the housing. “Coupled” may be understood as a detachable or non-detachable connection, particularly however the action of pressing the rim of the base body against the housing.

The proposed venting and separating device serves for separating particles starting at a certain size from hot gas flows which typically can be hotter than 200° C. In this context, the actually exiting fluid flow is not additionally hindered so that due to the particles separating at the filter the pressure loss does not increase impermissibly. The venting and separating device can advantageously comprise a particularly flat configuration.

The venting and separating device comprises a pressure relief valve by means of which excess pressure occurring in the failure situation can be quickly relieved in order to avoid damage to the housing. For example, a housing for lithium ion batteries may be concerned in which gases emerging in case of a cell defect must be discharged very quickly from the housing. Often, it is however necessary to prevent that the particles emerging in the failure situation and flowing out with the gases reach the environment.

The venting and separating device which may be preferably produced substantially of sheet metal, can be mounted, for example, at an exterior side of the housing in the region of housing openings in order to prevent in this way simply and inexpensively the escape of particles into the environment. This is enabled by at least two separation screens provided at and/or in a base body of the venting and separating device through which the exiting gas must flow in order to reach the environment. The separation screens are suitable to effectively retain the particles so that they are retained within the venting and separating device.

It is possible to connect a plurality of separation screens one after another to enable serial flow therethrough in order to first separate the largest then the fine particles, for example. A sufficient seal tightness between base body and separation screen or between base body and housing and environment is a prerequisite in this context.

Moreover, a bypass function in the form of a pressure relief valve can be integrated into the base body in case that the particles clog the separation screens so much that an impermissibly high pressure would occur in the interior of the housing. It is further conceivable to integrate in the venting and separating device a burst disk that opens at a corresponding excess pressure. It can be manufactured, for example, of metal but also of thermoplastic materials. When the material is sufficiently air-permeable due to a microporous structure, the venting and separating device can also provide for a permanent pressure compensation between environment and housing interior in normal operation.

In this manner, it is possible to realize very inexpensively an effective venting and separating device for particles, wherein, by the selection of corresponding separators and dimensions, such as surface, length, and diameter, the size distribution and quantity and/or weight of the particles can be adapted in accordance with the requirements and the pressure loss in the system can be optimized. Moreover, the venting and separating device can be mounted in a simple manner from the exterior at the battery housing and provides the possibility of integrating further functions such as, for example, a burst disk, a permanent pressure compensation, a bypass for the situation that the separation screens become clogged.

By means of the proposed venting and separating device, particles that, in case of a failure of components that are located in the interior of the housing, for example, of lithium ion cells in a high-voltage store, are entrained together with the gases produced in this context out of the housing for pressure relief can be advantageously effectively separated so that they cannot reach the environment together with the outflowing gases. The venting and separating device provides for this purpose an inexpensive, robust, scalable solution that can be optimized with respect to particle separation and pressure loss. Thus, particles, in particular hot (lithium) particles which are released in case of a cell defect of individual or a plurality of battery cells, can be retained by the venting and separating device and cannot reach unhindered the environment.

In a preferred embodiment, the bypass fluid flow path bypasses both separation screens. In other words, the bypass fluid flow path branches off in this context at a location of the venting flow direction that is fluidically upstream of the first as well as of the second separation screen.

According to a beneficial embodiment of the venting and separating device, the pressure relief valve can be formed in that the base body in a mounted state can be pressed by means of at least one pretensioned spring element seal-tightly against the housing. In this way, the base body can be lifted off the housing at an excess pressure that is predetermined by the spring element so that a fluid path for fast fluid relief opens by bypassing at least one or all of the separation screens. After relief of the excess pressure, the base body can contact again seal-tightly the housing so that the seal tightness of the housing is restored again.

In embodiments, the base body can comprise at least one force action region where the spring element can engage for transmitting a pretension force, wherein the force action region preferably is in the form of a radial projection or indentation of the base body.

According to a beneficial embodiment of the venting and separating device, the pressure relief valve can be formed in that the base body comprises at least one rated break site or rated deformation site, in particular in a sidewall. In an alternative embodiment of the pressure relief valve, the rated break site that can be embodied as a notch or embossment can thus rupture in case of an emerging excess pressure in the housing. In this way, a larger opening through which the produced gas, for example, of a defective battery cell, can flow into the environment.

According to a beneficial embodiment of the venting and separating device, the rated break site or rated deformation site can be designed as a flap that can swing outwardly toward the environment. For example, three sides of a rectangular flap can comprise perforations or notches as rated break site which, in case of an emerging excess pressure, can rupture so that the flap can swing outwardly. Due to the thus resulting opening, the produced gas can flow out of the interior of the housing into the environment.

The flap can be embodied, for example, by two spaced apart, preferably parallel, slits in the base body as well as at least one hinge that is extending between the slits, wherein the hinge preferably is in the form of a rated deformation region. The rated deformation region can comprise a hinge slit which is interrupted by webs that connect the base body to the flap. In embodiments, the hinge can be formed also as a film hinge. The number and dimensions of the webs that are required for reaching a predetermined switching pressure depends on the material parameters of the base body material and the geometry (in particular thickness) thereof. The slits which partially form the flap can be in particular present at a sidewall of the base body and extend to an edge of this sidewall which is facing the housing in the mounted state. In this way, the flap can be formed with a minimal number of slits. In this case, there is no material break but a preferably plastic deformation of a base body material when the flap swings open.

According to a beneficial embodiment of the venting and separating device, the first separation screen can be provided for separation of coarse particles and the second separation screen for separation of fine particles. In this way, the larger particles can be advantageously filtered out of the fluid flow by means of the first separation screen. The smaller particles that have still passed through can be separated at the second separation screen so that at most smallest particles can reach the exterior.

In an advantageous further embodiment, a medium for depth filtration of particles can be arranged between the first separation screen and the second separation screen.

In case of a depth filter, the particle separation is realized in the depth of the filter medium. In contrast to the surface filter, the formation of a filter cake is expressly unwanted in the depth filtration. In contrast to a surface filter, a depth filtration medium does not work according to the “screening effect” but based on a combination of the separation mechanisms interception, sedimentation, and diffusion.

In the following, the advantages of the use of a depth filter will be explained in more detail.

In case of the explosion of battery cells, particles of different size classes are produced. From the electrode materials, particles in a size range of 5 to 50 μm are released. Still finer are soot particles that are generated, for example, by combustion of the battery cell separator. Due to melting of metallic components such as current collectors, particles are formed which are in the size range of 100-1,000 μm. Fragments of cell housings are in the millimeter size range, for example. The separation of a broad particle size spectrum is a great procedural challenge because during the separation process a strong increase of the pressure loss must be avoided in order to ensure the desired gas escape from the battery housing. When pure surface filters, for example, screen structures, are used, the mesh width must be selected to be minimal which can lead to a fast blockage. Porous depth filters, on the other hand, separate also smaller particles at fiber structures in the depth of the filter medium, wherein the pressure loss increases only gradually. Such structures however can be blocked easily by large particles at the surface. Thus, the configuration of a multi-stage filtration cascade is expedient, wherein according to the invention a surface filter first separates the large particles and the smaller particles are then separated in the depth filter. A supplement of a filter stage for fine filtration downstream of the depth filter is advantageous.

According to a beneficial embodiment of the venting and separating device, the depth filter can comprise a nonwoven, in particular metal fiber nonwoven, and/or a foam, in particular a metal foam. In case of nonwovens, the separation of the particles can be realized by fibers of the nonwoven. In case of foams, the particle separation can be realized by stays of the material. Due to such a three-dimensional structure of the depth filter, even particles can be reliably separated that, for a small transverse diameter, comprise a comparatively large length extension.

According to a beneficial embodiment of the venting and separating device, the depth filter can be of a multi-stage configuration, wherein a first stage of the depth filter is embodied for separation of large particles, in particular at least 1 mm, and a second stage of the depth filter following in venting flow direction for separation of small particles, in particular at least 0.1 mm. The depth filter can thus be formed of a plurality of nonwovens or sponges. In this manner, particles can be received in the depth filter as in a sponge so that the risk that separated particles clog the venting fluid flow path is reduced. In this way, it can be effectively avoided that the venting and separating device can become clogged and that a built-up excess pressure cannot be relieved quickly enough, which could lead to damage to the housing.

According to a beneficial embodiment of the venting and separating device, an inflow surface of the depth filter can be larger by at least 15% than a geometric cross section of an opening of the housing provided for venting. In this way, the separation effect of the depth filter can be utilized beneficially and a fast pressure relief of the excess pressure in the housing can still be ensured.

According to a beneficial embodiment of the venting and separating device, the depth filter can comprise a density gradient along a flow-through direction. Due to such a three-dimensional structure of the depth filter, particles can also be reliably separated that for a small transverse diameter have a comparatively large length extension.

Alternatively or additionally, at least two, preferably metallic, media suitable for depth filtration with different density gradients can be arranged between the separation screens so that they can be serially flowed through.

According to a beneficial embodiment of the venting and separating device, the outlet opening can be arranged in the sidewall of the base body and/or in an end face of the base body which is facing the environment. In this manner, the exiting gas flow can be deflected in a targeted fashion by 90° so that it does not impact directly on a component arranged adjacent to the housing. Where possible, the gas flow can alternatively also be discharged directly via the end face of the base body. In this way, the existing flow resistance in the gas flow is possibly lower.

Advantageously, the base body can be provided at least partially outside of the housing for installation. In this way, the venting and separating device can be arranged at least partially in the exterior of the housing and saves in this way installation space in the housing, for example, for accommodating battery cells.

According to a beneficial embodiment of the venting and separating device, the base body and/or the first separation screen and/or the second separation screen can be embodied of a heat-resistant material, in particular of a heat-resistant plastic material and/or of metal, in particular sheet steel. In particular, the first and/or the second separation screen can be made of metal. Since the outflowing gas of battery cells is very hot, typically hotter than 200° C., it is advantageous to employ for the separation screens particularly heat-resistant materials such as metals, in particular sheet steel.

According to a beneficial embodiment of the venting and separating device, the first separation screen can be arranged so as to engage across a cross section of the base body. In this way, it is ensured that the entire exiting gas flow is filtered by the first separation screen. Alternatively or additionally, the outlet opening can be embodied as a second separation screen. In this manner, installation space for accommodating the second separation screen can be saved in the interior of the base body. The venting and separating device can therefore occupy a smaller installation space.

According to a beneficial embodiment of the venting and separating device, the venting flow direction can be deflected from the inlet opening to the outlet opening, in particular deflected by 90°. In this way, it can be achieved that no direct access to the interior of the housing via the venting and separating device is provided. This can be advantageous as splash protection, for example, when using steam cleaners for cleaning.

According to a beneficial embodiment of the venting and separating device, the second separation screen can be arranged within the base body, in particular can be covered by the base body. In this manner, it is possible to influence the flow guiding action in a targeted fashion and, for example, advantageously effect a deflection of the exiting gas flow.

According to a beneficial embodiment of the venting and separating device, the second separating screen can comprise a swirl-reducing or swirl-avoiding configuration. In particular, a surface of the second separation screen can be configured with a downward slope toward the outlet opening. By targeted deflection of the exiting gas flow in the interior of the base body, a swirl-reducing or even swirl-avoiding effect can be exerted on the gas flow. In this way, pressure loss upon exiting of the gas flow into the environment can be advantageously reduced so that a quicker relief of excess pressure is possible.

According to a beneficial embodiment of the venting and separating device, the second separation screen can comprise at least one elevation arranged in the venting flow direction upstream of the outlet opening. In particular, the elevation can extend parallel to the outlet opening in this context. In particular, the screen openings of the second separation screen are provided at a side of the elevation facing away from the outlet opening. In this way, it can be ensured that the separation screens cannot be reached from the exterior by means of a wire or wire-shaped tool and thus cannot be damaged. Also, the separation screens are protected in this way from a direct impact of water jets, for example, from a high-pressure cleaner.

According to a further aspect of the invention, a housing, in particular a battery housing, in particular of a traction battery of a motor vehicle, for receiving battery cells is proposed that comprises at least one housing wall with at least one housing opening, wherein the housing opening is closed off by a venting and separating device according to the invention, in particular at an exterior side of the housing wall.

The proposed housing that can be used in particular as a battery housing comprises a venting and separating device which serves for separation of particles starting at a certain size from hot gas flows which typically can be hotter than 200° C. In this context, the actually exiting fluid flow is not additionally impaired so that the pressure loss does not increase impermissibly due to the particles separating at the filter. The venting and separating device can advantageously comprise a particularly flat configuration so that advantageously a sufficient installation space for battery cells and/or electronics is provided in the housing.

The venting and separating device can be, for example, arranged in the housing but also outside of the housing or at least partially outside of the housing.

The venting and separating device comprises a pressure relief valve by means of which in a failure situation the occurring excess pressure can be quickly relieved in order to avoid a damage to the housing. For example, a housing for lithium ion batteries can be concerned in which, in case of a cell defect, the exiting gases must be discharged very quickly from the housing. Often, it is however required to prevent that particles, emerging in case of failure and flowing out together with the gases, reach the environment.

In this way, it is possible to realize a housing, for example, a battery housing, with a very inexpensive effective venting and separating device for particles, wherein, by the selection of corresponding separators and dimensions, such as surface, length, and diameter, the size distribution and quantity and/or weight of the particles can be adjusted in accordance with the requirements and the pressure loss in the system can be optimized. Moreover, the venting and separating device can be mounted in a simple manner from the exterior at the battery housing and provides the possibility of integrating further functions such as, for example, a burst disc, a permanent pressure compensation, a bypass for the case that the separation screens become clogged.

According to a beneficial embodiment of the housing, the venting and separating device can be arranged at least partially outside of the housing. In this way, the venting and separating device can be arranged at least partially in the exterior of the housing and saves in this way installation space in the housing, for example, for accommodating battery cells and/or battery electronics.

According to a beneficial embodiment of the housing, the housing opening can be closed by an areally spanned-across membrane, wherein the membrane is connected fluid-tightly to the housing opening.

The membrane that is embodied advantageously as a semipermeable membrane enables passage of gaseous media from an environment into the electronics housing and in reverse, but prevents however passage of liquid media and solids.

All materials can be used for the semipermeable membrane that comprise a gas permeability for venting in normal operation and a sufficiently high water impermeability. As preferred material for the semipermeable membrane, polytetrafluoroethylene (PTFE) can be used. The semipermeable membrane comprises an average pore size that can be between 0.01 micrometers and 20 micrometers. The porosity lies preferably at approximately 50%; the average pore size amounts to preferably approximately 10 micrometers.

The semipermeable membrane can be preferably designed as a film-like or film-shaped or disk-shaped thin membrane. The gas-permeable membrane comprises an effective membrane surface for the gas permeation which, at its outer circumference, preferably can comprise a rectangular or round outer contour. It is understood however that the outer circumference of the membrane can also be designed differently. The membrane is preferably a thin flat membrane whose membrane surfaces effective for the gas passage and facing away from each other are substantially parallel to each other and preferably are embodied substantially planar.

The membrane thickness of the membrane is very much smaller than its other outer dimensions. The membrane can span across a minimum width and/or a minimum length or a minimum outer diameter of equal to or larger than 20 mm, preferably of equal to or larger than 30 mm, in particular of equal to or larger than 40 mm. The membrane thickness can be in particular smaller at least 20 times, preferably at least 40 times, in particular at least 100 times, than the minimum width and/or minimum length or the minimum outer diameter of the membrane. The membrane thickness can amount to 1 micrometer to 5 millimeters, wherein a membrane thickness of 0.1 to 2 mm, in particular 0.15 to 0.5 mm, is preferred.

Moreover, the membrane can be circumferentially connected, in particular welded, to a rim of a gas passage opening of a base body, in particular of a degassing unit, preferably at an inner side of the base body. Alternatively, the membrane can also be glued or connected by frictional connection, for example, clamped. The porous PTFE membrane materials that are described herein as preferred can be welded to a plastic base body, or materially fused in other ways, without problem.

In case of a suddenly increasing pressure in the housing, for example, due to a defective battery cell, the membrane can be caused to rupture due to a targeted weakening, for example, by an emergency degassing spike, so that the hot gas of the battery cell can flow out of the housing.

### BRIEF DESCRIPTION OF DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 is an isometric section view of a venting and separating device according to an embodiment of the invention.

FIG. 2 is a longitudinal section view of the venting and separating device according to FIG. 1 with indicated section planes A-A and B-B.

FIG. 3 is a cross section view of the venting and separating device according to FIG. 1 along the section plane B-B.

FIG. 4 is a cross section view of the venting and separating device according to FIG. 1 along the section plane A-A.

FIG. 5 is an isometric illustration of the venting and separating device according to FIG. 1 with closed pressure relief valve.

FIG. 6 is an isometric illustration of the venting and separating device according to FIG. 1 with open pressure relief valve.

FIG. 7 is an isometric section view of a venting and separating device according to a further embodiment of the invention.

FIG. 8 is a longitudinal section view of the venting and separating device according to FIG. 7 with indicated section planes A-A and B-B.

FIG. 9 is a cross section view of the venting and separating device along the section plane B-B according to FIG. 8.

FIG. 10 is a cross section view of the venting and separating device along the section plane A-A according to FIG. 8.

FIG. 11 is an isometric illustration of the venting and separating device according to FIG. 7 with closed pressure relief valves.

FIG. 12 is an isometric illustration of the venting and separating device according to FIG. 7 with open pressure relief valves.

FIG. 13 is an isometric illustration of a venting and separating device according to a further embodiment of the invention.

FIG. 14 is an isometric section view of the venting and separating device according to FIG. 13.

FIG. 15 is a longitudinal section view of the venting and separating device according to FIG. 13 with indicated section plane A-A.

FIG. 16 is a cross section view of the venting and separating device along the section plane A-A according to FIG. 15.

FIG. 17 is a further longitudinal section view of the venting and separating device according to FIG. 13 with indicated section plane C-C.

FIG. 18 is a longitudinal section view of the venting and separating device along the section plane C-C according to FIG. 17.

FIG. 19 is an isometric illustration of the venting and separating device according to FIG. 13 with open pressure relief valve.

FIG. 20 is an isometric illustration of a venting and separating device according to a further embodiment of the invention.

FIG. 21 is a longitudinal section view of the venting and separating device according to FIG. 20 with indicated section planes A-A and B-B.

FIG. 22 is a further longitudinal section view of the venting and separating device according to FIG. 20 with indicated section plane C-C.

FIG. 23 is a cross section view of the venting and separating device along the section plane A-A according to FIG. 21.

FIG. 24 is a cross section view of the venting and separating device along the section plane B-B according to FIG. 21.

FIG. 25 is a longitudinal section view of the venting and separating device along the section plane C-C according to FIG. 22.

FIG. 26 is an isometric illustration of the venting and separating device according to FIG. 20 with open pressure relief valves.

### DETAILED DESCRIPTION

In the Figures, same or same type components are identified with same reference characters. The Figures show only examples and are not to be understood as limiting.

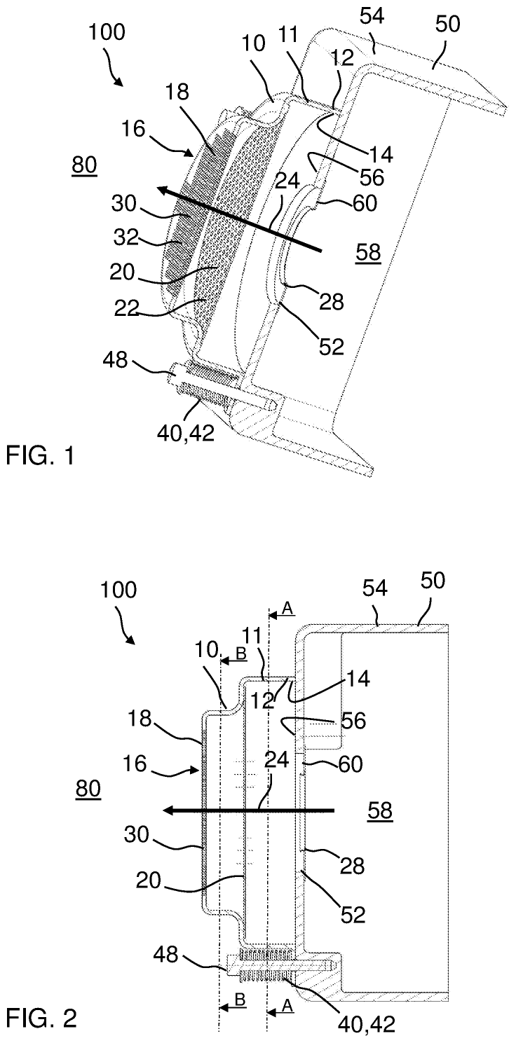

FIG. 1 shows an isometric section view of a venting and separating device 100 according to an embodiment of the invention, while in FIG. 2 a longitudinal section view of the venting and separating device 100 with indicated section planes A-A and B-B is illustrated.

The venting and separating device 100, in particular venting filter, for a degassing unit of a housing 50 comprises a base body 10 with a circumferentially extending rim 12 which is provided for coupling to the housing 50. Only that part of the housing 50 is illustrated at which the venting and separating device 100 is arranged.

The housing 50, in particular battery housing, in particular of a traction battery of a motor vehicle, serves for receiving battery cells. The housing 50 comprises a housing wall 54 with at least one housing opening 52. The housing opening 52 is covered by the venting and separating device 100 at the exterior side 56 of the housing wall 54.

The venting and separating device 100 is arranged outside of the housing 50. In an alternative embodiment, the venting and separating device 100 could however be installed also entirely or at least partially, in the interior of the housing 50.

The base body 10, which is designed in a cylinder shape, comprises an inlet opening 14, extending across the entire cross section area of the base body 10, and an outlet opening 18. For intended mounting at the housing 50, the single inlet opening 14 is in fluid communication with the interior 58 of the housing 50 through the housing opening 52 while the single outlet opening 18 is in fluid communication with the environment 80. The outlet opening 18 is arranged at the end face 16 of the base body 10 that is facing the environment 80.

Fluidically downstream in a venting flow direction 24 which is illustrated by an arrow, the base body 10 comprises a first separation screen 20 with first screen openings 22 that engages across the inlet opening 14. Fluidically downstream of the first separation screen 20, the base body 10 comprises a second separation screen 30 with second screen openings 32 that engages across the outlet opening 18. The two separation screens 20, 30 are thus serially flowed through by the outflowing gases.

The first separation screen 20 is provided for separation of coarse particles and the second separation screen 30 for separation of fine particles. In this context, the first separation screen 20 is arranged so as to engage across a cross section of the base body 10 while the outlet opening 18 is embodied as the second separation screen 30.

The base body 10 and/or the first separation screen 20 and/or the second separation screen 30 can be advantageously embodied of a heat-resistant material, in particular of a heat-resistant plastic material and/or of metal, in particular sheet steel.

In particular, the first and the second separation screens 20, 30 can be made of metal because the gases which are exiting in case of a cell defect can reach very high temperatures, for example, 200° C. and more.

The housing opening 52 is closed by an areally spanned-across membrane 60. The membrane 60 is preferably embodied as a semipermeable membrane and is fluid-tightly connected to the housing opening 52. In the here illustrated Figures, the membrane 60 is illustrated with a gas passage opening 28, respectively. This state results when such a high excess pressure has been produced in the interior 58 of the housing 50 that the membrane 60 has either ruptured on its own or, for example, by means of an emergency degassing spike (not illustrated), has been weakened to such an extent that it ruptures.

In the venting and separating device 100, a pressure relief valve 40 is provided that, as intended, in case of excess pressure in the housing 50, opens a bypass fluid flow path 26 from the interior 58 of the housing 50 to the environment 80, wherein the bypass fluid flow path 26 is arranged fluidically upstream relative to at least one of the separation screens 20, 30. The pressure relief valve 40 is formed in that the base body 10, for intended mounting, is pressed by three pretensioned spring elements 42 substantially fluid-tightly against the housing 50. The spring elements 42 which are embodied as coil pressure springs are pretensioned by fastening screws 48 against the housing 50 and press thus the base body 10 by means of the rim 12 substantially fluid-tightly against the exterior side 56 of the housing 50 in normal operation.

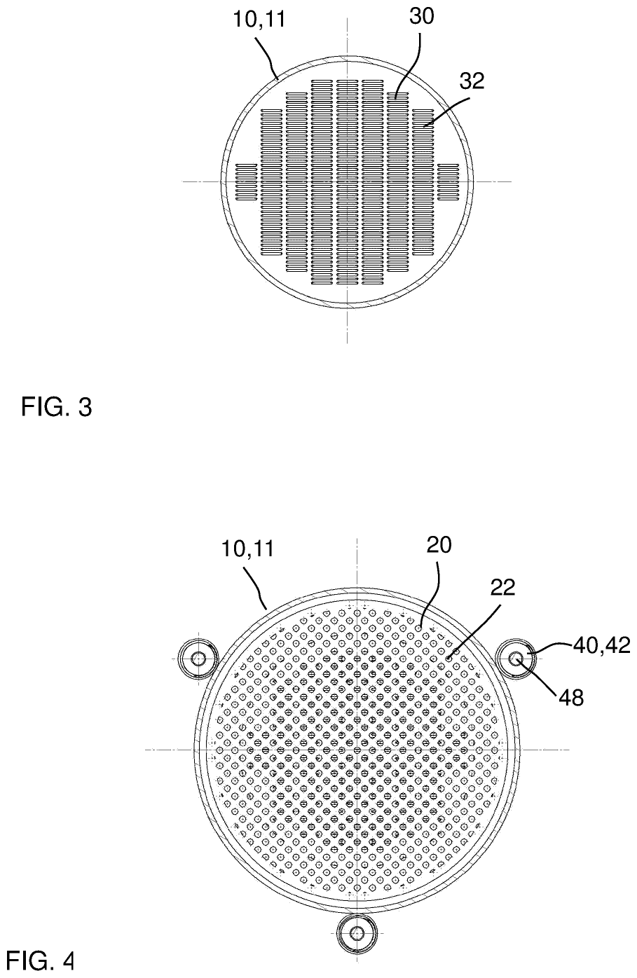

FIG. 3 shows a cross section through the venting and separating device 100 according to FIG. 1 along the section plane B-B according to FIG. 2, while FIG. 4 shows a cross section of the venting and separating device 100 along the section plane A-A according to FIG. 2.

In the illustrated section views, the second separation screen 30 (FIG. 3) or the first separation screen 20 (FIG. 4) can be seen in the plan view. The first separation screen 20 is provided for coarse separation of particles and comprises circular screen openings 22, while the second separation screen 30 is provided for fine separation of particles and comprises slit-shaped screen openings 32. The first separation screen 20 can separate, for example, particles with a diameter greater than 1.5 mm, while the second separation screen 30, for example, can separate particles with a diameter greater than 1.0 mm.

FIG. 4 shows also the three fastening screws 48, arranged about the circumference of the cylinder-shaped venting and separating device 100, with the spring elements 42 arranged around them as pressure relief valve 40.

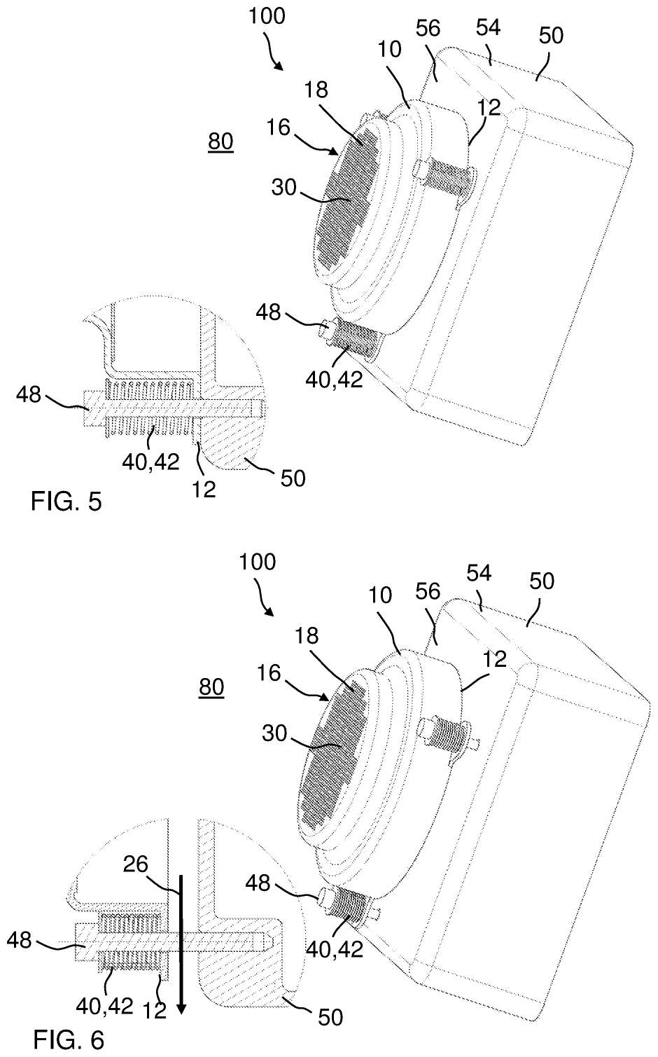

FIG. 5 shows an isometric illustration of the venting and separating device 100 according to FIG. 1 with closed pressure relief valve 40, wherein the base body 10 with the rim 12 is contacting substantially fluid-tightly the exterior side 56 of the housing 50.

In FIG. 6, the venting and separating device 100 is illustrated with open pressure relief valve 40. In this context, the rim 12 of the base body 10 is lifted off the exterior side 56 of the housing 50. The spring element 42 of the pressure relief valve 40 is compressed by the excess pressure produced in the interior 58 of the housing 50. In this way, the fluid path 26, illustrated by the arrow, opens and the produced gases can flow out into the environment 80.

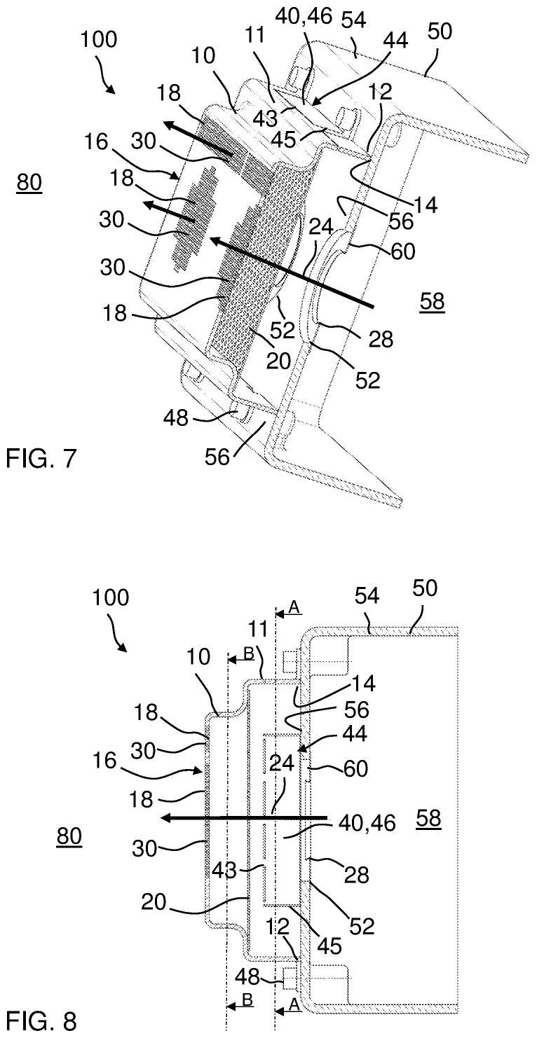

FIG. 7 shows an isometric section view of a venting and separating device 100 according to a further embodiment of the invention, while a longitudinal section view of the venting and separating device 100 with indicated section planes A-A and B-B is illustrated in FIG. 8.

In this embodiment, the base body 10 that is designed in a rectangular shape comprises at the end face 16 a total of four outlet openings 18, namely two adjacently positioned rectangular and two adjacently positioned circular outlet openings 18. These outlet openings 18 are also designed as second separation screens 30. The first separation screen 20, as in the preceding embodiment, is embodied across the entire cross section area of the inlet opening 14 of the base body 10.

The base body 10 is substantially fluid-tightly mounted with the rim 12 to the exterior side 56 of the housing 50 via fastening tabs by means of fastening screws 48. As can be seen in FIG. 7, the housing 50 comprises two adjacently positioned housing openings 52 above which the venting and separating device 100 is substantially fluid-tightly arranged. The two housing openings 52 are each illustrated covered with membranes 60 which already comprise a gas passage opening 28.

This venting and separating device 100 comprises a different type of pressure relief valve 40. The pressure relief valves 40 are formed in that the base body 10 comprises one or a plurality of rated deformation site(s) 44. The rated deformation site 44 is designed as a flap 46 which can swing toward the environment 80 and is outwardly pivotable. The flap 46 comprises two spaced-apart slits 45 in the sidewalls 11 between which a rated deformation region 43 extends that functions as a hinge of the flap 46. The slits 45 and/or the rated deformation region 43 can be provided in the form of perforations of the base body, wherein these perforations tear open in case of excess pressure and the flap 46 can pivot outwardly.

The rated deformation region 43 which functions as a hinge of the flap 46 comprises a hinge slit that is interrupted by a plurality of webs that connect the flap body to the base body. By means of the geometry as well as of the material properties of these webs, the release pressure of the pressure relief valve 40 designed in this way can be significantly influenced.

Due to the thus produced openings, the gas can flow out of the interior 58 of the housing 50 into the environment 80. The flaps 46, once they have opened, cannot close again. Herein resides a significant difference to the pressure relief valves 40 realized by means of a spring element 42 which close again as the pressure decreases in the interior 58 of the housing 50.

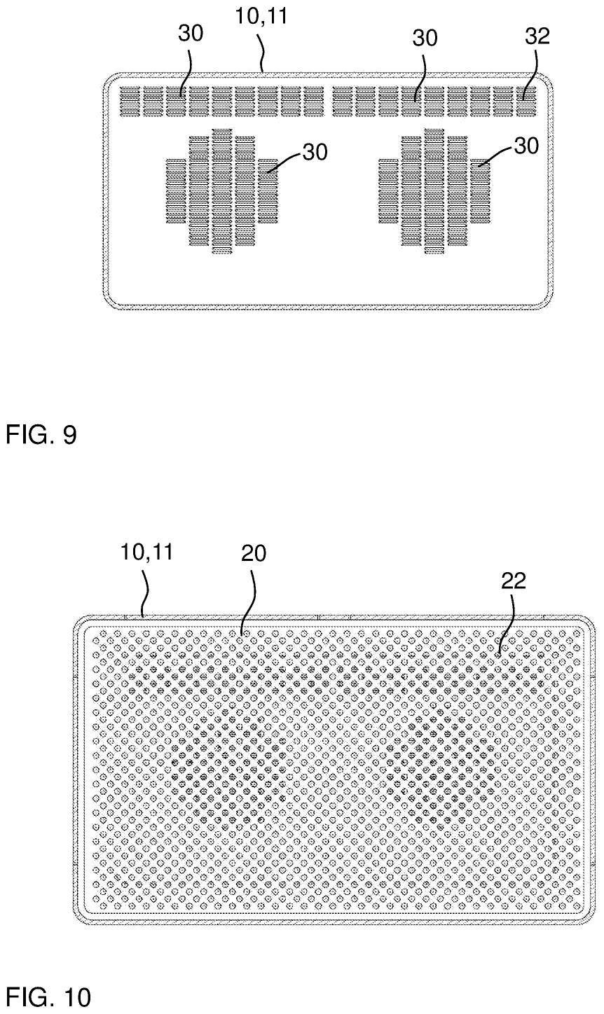

FIG. 9 shows a cross section through the venting and separating device 100 along the section plane B-B according to FIG. 8 with a plan view of the second separation screen 30, while FIG. 10 shows a cross section view of the venting and separating device 100 along the section plane A-A according to FIG. 8 with a plan view of the first separation screen.

The second separation screens 30 are again embodied with slit-shaped screen openings 32 while the single separation screen 20 is configured with circular screen openings 22.

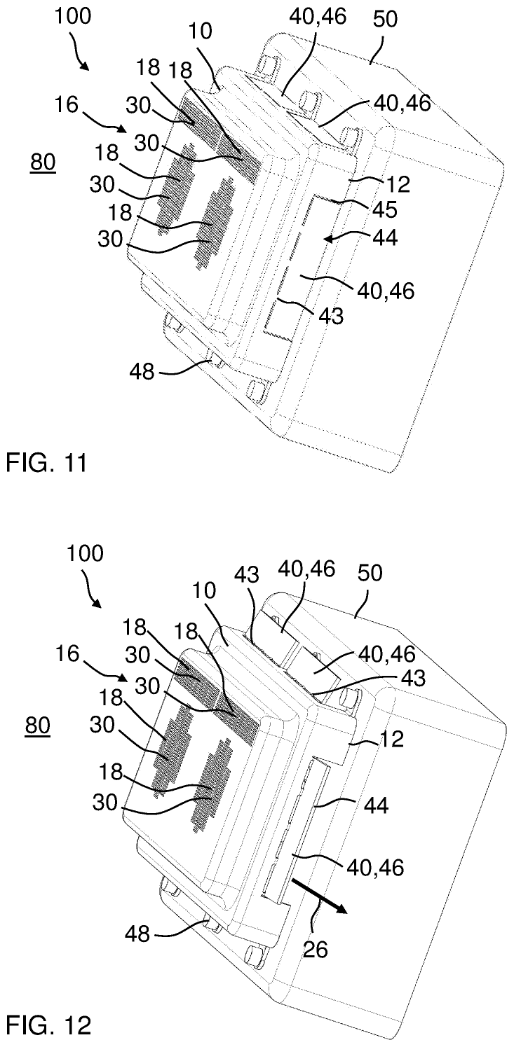

In FIG. 11, the venting and separating device 100 is illustrated with closed pressure relief valves 40, while in FIG. 12 the venting and separating device 100 is illustrated with open pressure relief valves 40.

The two longer sidewalls 11 of the base body 10 each comprise in this context two flaps 46 while the two shorter sidewalls 11 each have only one flap 46. In

FIG. 12, it can be seen how the flaps 46 swing outwardly toward the environment 80 and release an opening for the fluid path 26, respectively. For reasons of simplification, only one arrow is illustrated as fluid path 26. Of course, the gas flows in the same manner through the other flaps 46.

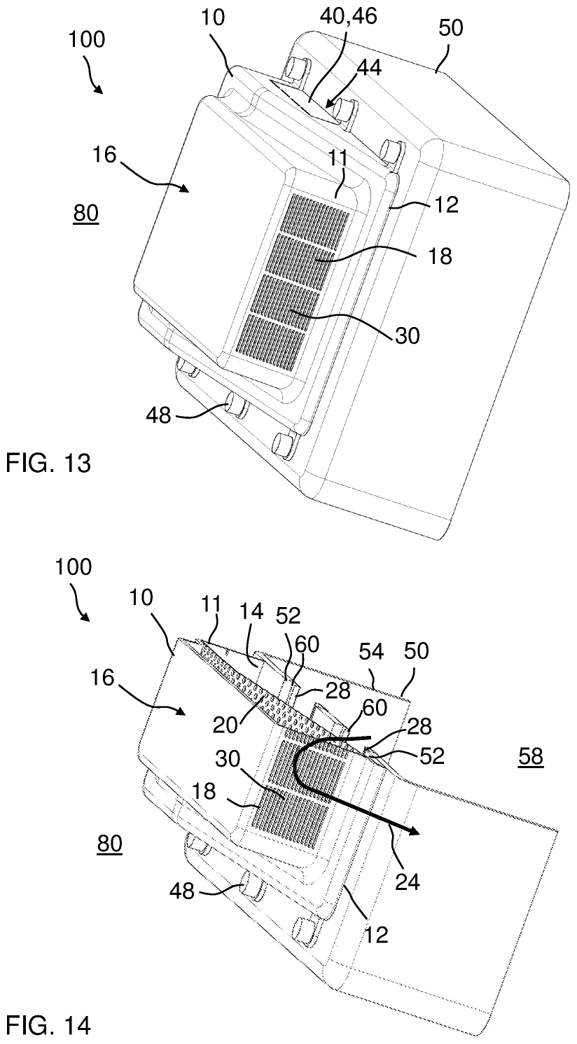

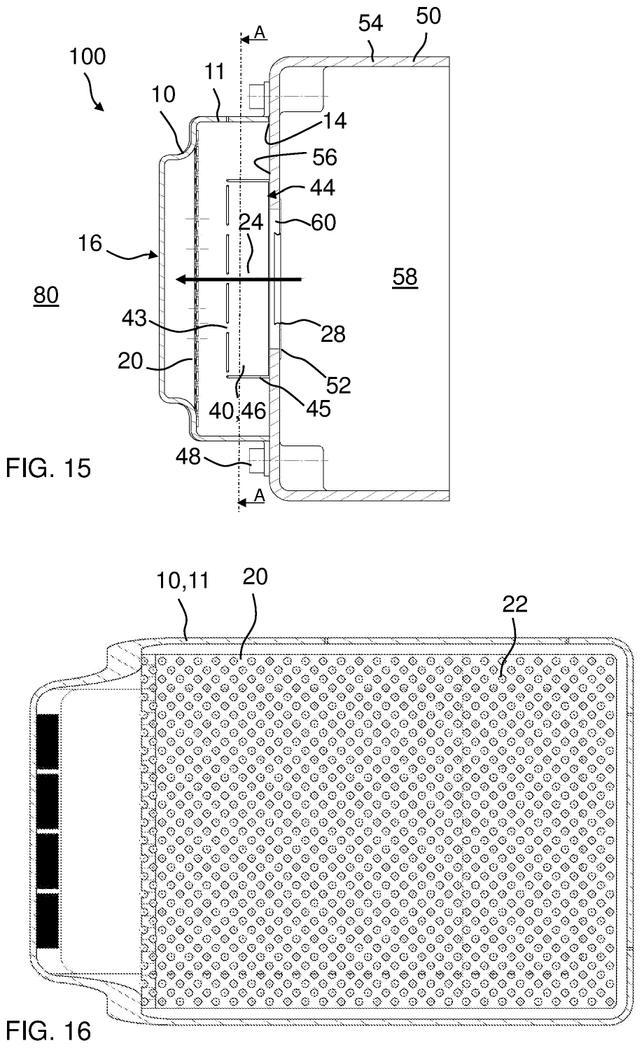

FIG. 13 shows an isometric illustration of a venting and separating device 100 according to a further embodiment of the invention. FIG. 14 shows an isometric section view of the venting and separating device 100, while in FIG. 15 a longitudinal section view of the venting and separating device 100 with indicated section plane A-A is illustrated.

The rectangular base body 10 is substantially fluid-tightly mounted with the rim 12 to the exterior side 56 of the housing 50 via fastening tabs by means of fastening screws 48. As can be seen in FIG. 14, the housing 50 comprises two adjacently positioned housing openings 52 above which the venting and separating device 100 is substantially fluid-tightly arranged. The two housing openings 52 are each illustrated covered with membranes 60 which already comprise a gas passage opening 28.

In this embodiment, the venting flow direction 24 is deflected by 90° from the inlet opening 14 to the outlet opening 18, i.e., the outflow of the gas takes place toward the side of the base body 10. For this purpose, the base body 10 comprises in one side wall 11 an outlet opening 18 which is configured as a second separation screen 30.

The first separation screen 20 is arranged in the interior of the base body 10 and is configured with a downward slope toward the outlet opening 18.

FIG. 16 shows a cross section view of the venting and separating device along the section plane A-A according to FIG. 15 in which a plan view of the first separation screen 20 with circular screen openings 22 can be seen.

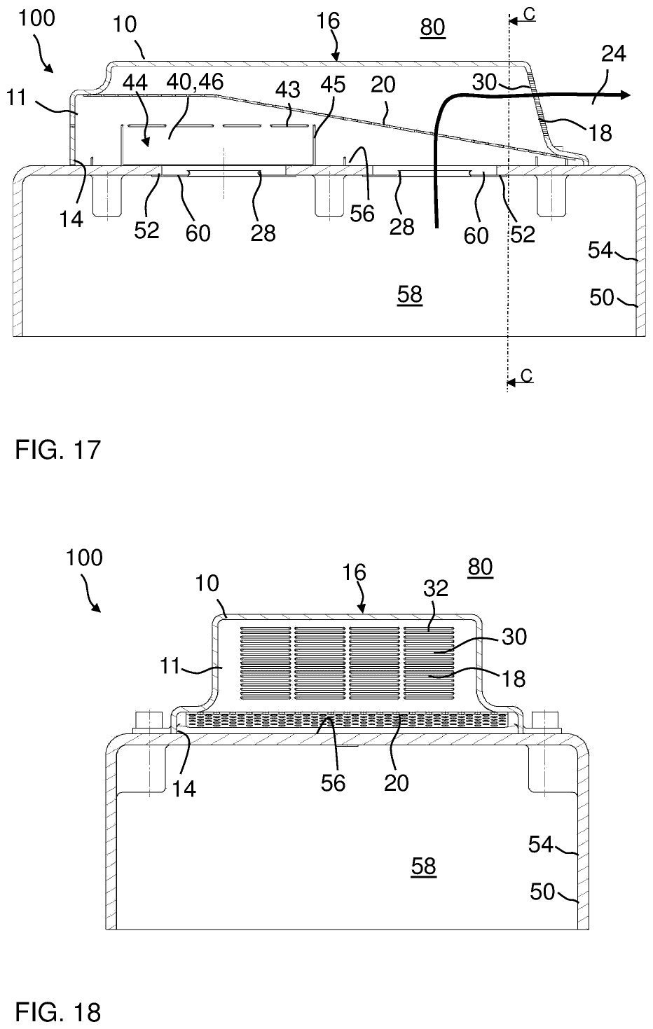

The downward slope of the first separation screen 20 can be seen in particular in FIG. 17 in which a further longitudinal section view of the venting and separating device 100 with indicated section plane C-C is illustrated. In this context, the venting flow direction 24 toward the side of the base body 10 is also illustrated as an arrow.

FIG. 18 shows a longitudinal section view of the venting and separating device 100 along the section plane C-C of FIG. 17. In this context, the outlet opening 18 with slit-shaped screen openings 32 can be seen together with the first separation screen 20 arranged underneath.

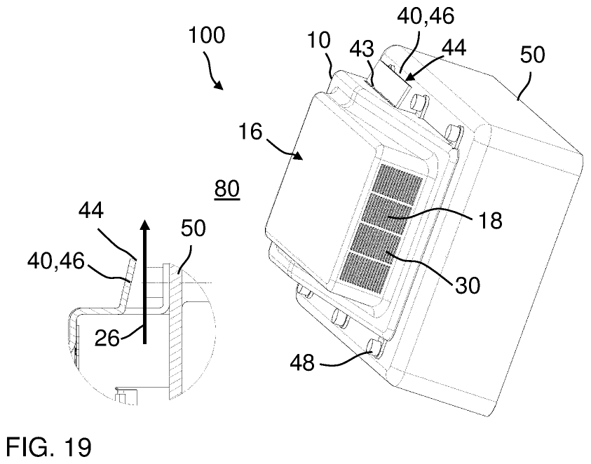

As in the preceding embodiment, the embodiment illustrated in the FIGS. 13 to 19 comprises pressure relief valves 40 that are embodied as flaps 46 in the sidewalls. FIG. 13 shows the venting and separating device with closed pressure relief valve 40. FIG. 19 shows the venting and separating device 100 according to FIG. 13 with open pressure relief valve 40 and indicated bypass fluid flow path 26. The pressure relief valve 40 which is arranged at the oppositely positioned sidewall 11 cannot be seen in the illustration.

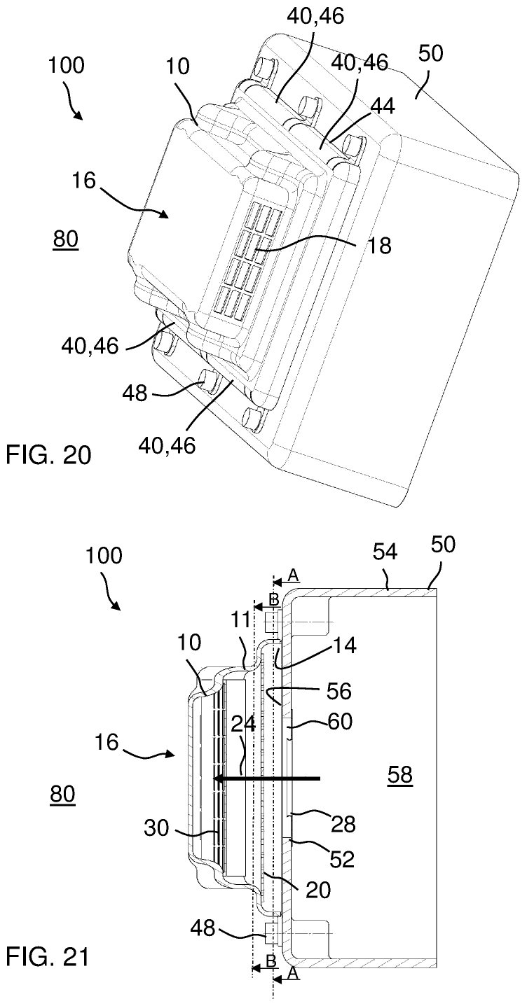

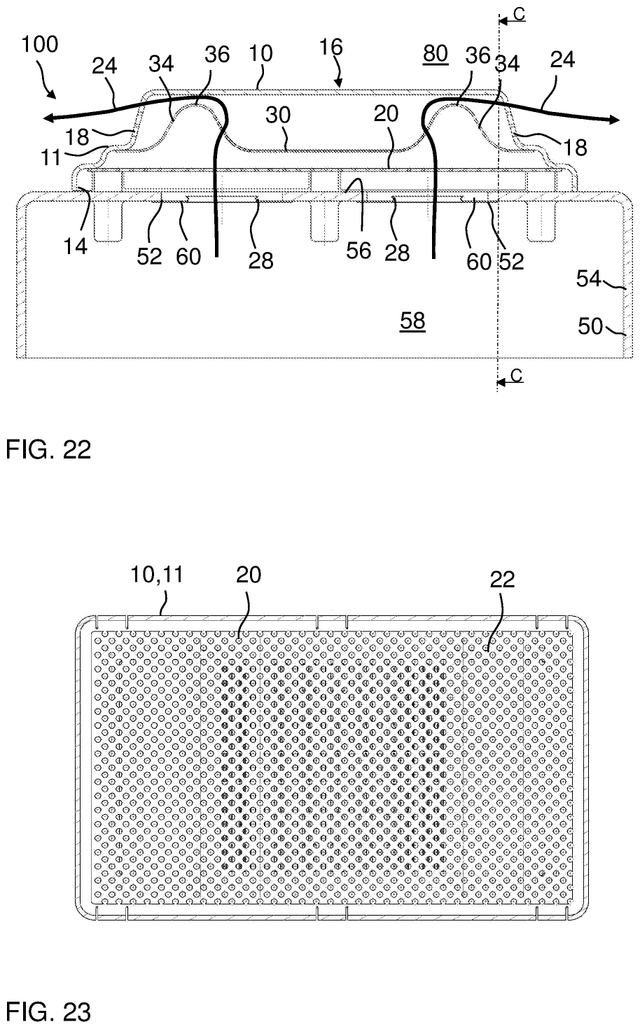

FIG. 20 shows an isometric illustration of a venting and separating device 100 according to a further embodiment of the invention, while in FIG. 21 a longitudinal section view of the venting and separating device 100 with indicated section planes A-A and B-B is illustrated. FIG. 22 shows a further longitudinal section view of the venting and separating device 100 with illustrated section plane C-C.

The rectangular base body 10 is substantially fluid-tightly mounted with the rim 12 at the exterior side 56 of the housing 50 via fastening tabs by means of fastening screws 48. As can be seen in FIG. 22, the housing 50 comprises two adjacently positioned housing openings 52 above which the venting and separating device 100 is arranged substantially fluid-tightly. The two housing openings 52 each are illustrated covered with membranes 60 which already comprise a gas passage opening 28.

In this embodiment, outlet openings 18 are arranged in oppositely positioned sidewalls 11 of the base body 10. These outlet openings 18 are however not embodied as second separation screens but serve only as openings for the outflowing gas. The venting flow direction 24 is indicated with arrows.

The second separation screen 30 is arranged instead inside of the base body 10 and is covered in particular by the base body 10. The second separation screen 30 comprises namely a configuration for special protection of the separation screens. For this purpose, in particular a surface 34 in the form of an elevation 36 arranged in venting flow direction 24 fluidically upstream of the outlet opening 18 is designed with a downward slope toward the outlet opening 18. The elevations 36 each extend parallel to the outlet opening 18. In this way, a direct access to the separation screens, even by means of a wire-shaped auxiliary means, is not possible and also a direct impact of a water jet, for example, from a high-pressure cleaner, is excluded.

The screen openings of the second separation screen 30 are positioned in this embodiment at a side of the elevation 36 which is facing away from the outlet opening 18, which means a further improved protective function from mechanical damage for the first and second separation screens 20, 30.

As in the preceding embodiments, the first separation screen 20 with circular screen openings 22 is arranged such that it covers the entire cross section area of the inlet opening 14 of the base body 10.

In a cross section view of the venting and separating device 100 along the section plane A-A according to FIG. 21, FIG. 23 shows a plan view of the first separation screen 20 with circular screen openings 22.

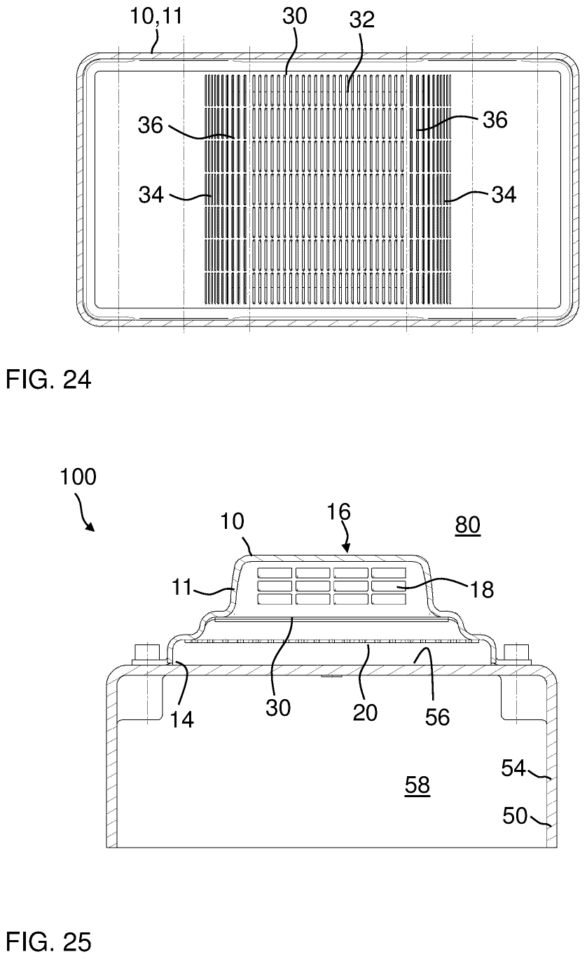

FIG. 24 shows a cross section view of the venting and separating device 100 along the section plane B-B according to FIG. 21 with a plan view of the second separation screen 30 which comprises slit-shaped screen openings 32.

FIG. 25 shows a longitudinal section view of the venting and separating device 100 along the section plane C-C according to FIG. 22 in which the first and the second separation screens 20, 30 and moreover an outlet opening 18 can be seen.

As in the preceding embodiment, the embodiment illustrated in FIGS. 20 to 26 comprises pressure relief valves 40 embodied as flaps 46 in the sidewalls. FIG. 20 shows in this connection the venting and separating device 100 with closed pressure relief valves 40.

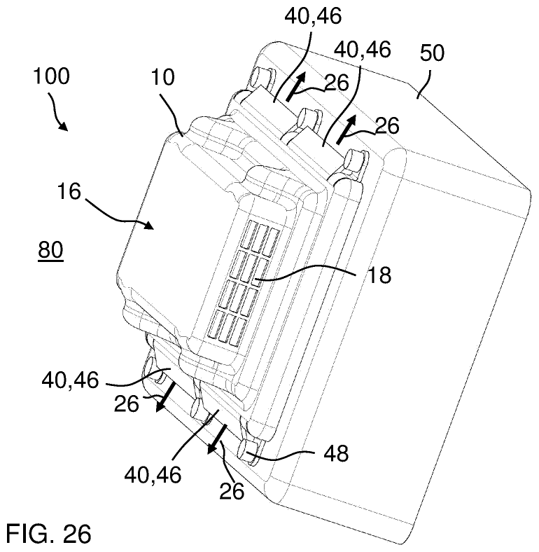

In FIG. 26, the venting and separating device 100 is illustrated with open pressure relief valves 40 which, as flaps 46 arranged on oppositely positioned sidewalls 11, swing outwardly. Bypass fluid flow paths 26 of the outflowing gas are illustrated by arrows.

1. A venting and separating device for a housing of a battery, the venting and separating device comprising:
a base body comprising:
a circumferentially extending rim configured to couple to the housing;
an inlet opening configured to be in fluid communication to an interior of the housing;
an outlet opening configured to be in fluid communication with an environment;
a first separation screen comprising first screen openings engaging across the inlet opening; and
a second separation screen in a venting flow direction fluidically downstream of the first separation screen, the second separation screen comprising second screen openings engaging across the outlet opening; and
a pressure relief valve configured to open, when a predetermined excess pressure in the housing is surpassed, a bypass fluid flow path from the interior of the housing to the environment, the bypass fluid flow path bypassing both the first separation screen and the second separation screen.

2. The venting and separating device according to claim 1, wherein the pressure relief valve comprises a pre-tensioned spring element configured to press the base body, in a mounted state, seal-tightly against the housing, and
the base body is configured to, when the predetermined excess pressure in the housing is surpassed, lift off the housing, opposite to the pre-tensioned spring element, with opening of the bypass fluid flow path.

3. The venting and separating device according to claim 2, wherein the base body further comprises a force action region where the pre-tensioned spring element is configured to engage to transmit a pretension force.

4. The venting and separating device according to claim 1, wherein the pressure relief valve comprises a rated break site or rated deformation site in a sidewall of the base body.

5. The venting and separating device according to claim 4, wherein the rated break site or rated deformation site comprises a flap pivotable toward the environment.

6. The venting and separating device according to claim 5, wherein the flap comprises parallel slits in the base body, and a hinge extending between the parallel slits.

7. The venting and separating device according to claim 1, wherein the first separation screen is configured to separate coarse particles, and the second separation screen is configured to separate fine particles.

8. The venting and separating device according to claim 1, wherein the base body further comprises a medium for depth filtration of particles and arranged between the first separation screen and the second separation screen.

9. The venting and separating device according to claim 8, wherein the medium for depth filtration comprises a density gradient so that, in the venting flow direction, increasingly smaller particles rare separated.

10. The venting and separating device according to claim 1, wherein the outlet opening is arranged in a sidewall of the base body and/or in an end face of the base body, the end face facing the environment.

11. The venting and separating device according to claim 1, wherein any one or any combination of the base body, the first separation screen and the second separation screen comprise a heat-resistant material.

12. The venting and separating device according to claim 1, wherein the first separation screen is arranged across a cross section of the base body, and
the outlet opening is embodied as the second separation screen.

13. The venting and separating device according to claim 1, wherein the venting flow direction is deflected from the inlet opening to the outlet opening.

14. The venting and separating device according to claim 1, wherein the second separation screen is arranged inside of the base body.

15. The venting and separating device according to claim 14, wherein the second separation screen comprises a swirl-reducing or swirl-avoiding configuration, in which a surface of the second separation screen comprises a downward slope toward the outlet opening.

16. The venting and separating device according to claim 15, wherein the second separation screen comprises an elevation arranged in the venting flow direction in front of the outlet opening.

17. A housing of a battery, the housing comprising:
a housing wall comprising a housing opening; and
a venting and separating device closing the housing opening and comprising:
a base body comprising:
a circumferentially extending rim configured to couple to the housing;
an inlet opening configured to be in fluid communication to an interior of the housing;
an outlet opening configured to be in fluid communication with an environment;
a first separation screen comprising first screen openings engaging across the inlet opening; and
a second separation screen in a venting flow direction fluidically downstream of the first separation screen, the second separation screen comprising second screen openings engaging across the outlet opening; and
a pressure relief valve configured to open, when a predetermined excess pressure in the housing is surpassed, a bypass fluid flow path from the interior of the housing to the environment, the bypass fluid flow path bypassing both the first separation screen and the second separation screen.

18. The housing according to claim 17, wherein the venting and separating device is arranged at least partially outside of the housing.

19. The housing according to claim 17, wherein the venting and separating device further comprises an areally spanned-across membrane closing the housing opening, the membrane being connected fluid-tightly to the housing opening.
